(19) United States
(12) Patent Application Publication
(10) Pub. No.: US 2002/0027727 A1
(43) Pub. Date: Mar. 7, 2002

(54) Rearview mirror assembly for a vehicle

(76) Inventors: Heinrich Lang, Ergersheim (DE); Wolfgang Seiboth, Bad Windsheim (DE); Stefan Centmayer, Ergersheim (DE)

Correspondence Address: DORITY & MANNING, P.A., POST OFFICE BOX 1449, GREENVILLE, SC, 29602-1449, US

(21) Appl. No.: 09/760,608

(22) Filed: Jan. 16, 2001

(30) Foreign Application Priority Data
Sep. 5, 2000 (DE) 10043750.8

(51) Int. Cl. G02B 7/02

(52) U.S. Cl. 359/879; 359/838; 359/821

(57) ABSTRACT

Proposed is a rearview mirror in which a reflective coating (16) is found on the outer side (12) of a mirror carrier (6). This carrier (6) then, no longer serves for the support of a separate mirror element, for instance, a glass plate or the like and further the carrier (6) is not provided on its own inner surface (14) with the reflective coating (16). In other words, the carrier (6), that is, the material of the carrier (6), need not show any special qualities of an optical nature. Thus, preparatory steps for the machining and finishing of the inner surface (14), such as polishing, before application of the reflective coating (16), which steps are expensive in time and cost, can be dispensed with, since the reflective coating (16) is, in the present invention, directly on the outside (12) of the said carrier.

### FIELD OF THE INVENTION

The invention concerns a rearview mirror, especially for motor vehicles. More particularly, the invention relates to a rearview mirror having a carrier plate that is coated to have a reflective surface.

### BACKGROUND OF THE INVENTION

Conventionally, in the design and manufacture of rearview mirrors, the actual mirror, for instance, a glass plate with vaporized deposit or the like on the mirror's rear side, is supported on a mirror carrier plate. The plate in turn is secured within a mirror housing. The connection between the mirror carrier plate and the housing can be a rigid connection or a positioning device may be interposed.

DE 80 34 459.8 discloses an inside rearview mirror for automobiles in which the mirror carrier plate is made out of a transparent plastic material that is treated on the rear side with a reflective coating, possibly by vapor deposition. In this arrangement, the necessity of having two separate components is eliminated; namely, the actual mirror element (for instance, the rear side vapor-deposited or coated-glass plate) and the mirror carrier plate may be dispensed with. This is advantageous from the standpoint of reducing manufacturing costs when weight savings or the like are considered.

It is questionable in regard to the inside rearview mirror as taught by DE 80 34 459.8, whether the mirror carrier plate, designed in the form of a transparent plastic component and provided on the rear side with a reflective coating, meets the high optical demands it must fulfill so that the mirror—when supported by the carrier plate—still possesses satisfactory optical characteristics.

Immediately upon the casting or the pressing of high-transparency plastics, problems arise that impair the optical characteristics of the such components. Examples of difficulties inherent in such pressed material are streaks in the plastic, air inclusions or surface irregularities, which degrade the optical characteristics of a plastic component of this type in a manufactured mirror. If, for instance, a specific surface roughness of the transparent plastic component lies on that side which is provided with the reflective coating, for instance by vapor deposition, then the eventual mirror will possess poor reflecting characteristics and show a tendency toward distortion of the image.

To avoid the above problems, it is necessary to process the mirror carrier plate, in this instance, the transparent plastic component, before the application of the reflective coating. This processing comprises, in particular, a polishing step in order to obtain the smoothest possible surface, which later receives the reflective coating. Overlooking for the moment that this is an expensive and time consuming operation, the inherent imperfections in the plastic material itself, notably the mentioned streaking and air inclusions, etc., are not removed by the polishing. On this account, during the manufacture of inside rearview mirrors in the manner proposed by DE 80 34 459.8, a relatively high rejection quota must be expected.

### SUMMARY OF THE INVENTION

Thus, the present invention is directed to an inside rearview mirror in accordance with the generic concept of a mirror which does not exhibit the above described problems. This is achieved in a surprisingly simple manner in that the reflective coating is applied onto the front side of the plastic carrier component.

The disadvantages and the problems mentioned in the above introductory passages, which are current in the state of the technology, are overcome by the present invention at one stroke. The necessity for making available two separate components, that is, the mirror and the mirror carrier, can now be done away with. Further, problems arising from the employment of DE 8034459.8 do not occur with the present invention since the carrier plate or the carrier itself is provided on its front side with the reflective coating.

With the present invention, the optical characteristics of the material of the carrier or the carrier plate are relatively unimportant since the incident light and the light reflected by the mirror surfacing does not have to pass through the material of the carrier. Thus, the light experiences no optical distortions.

Further advantageous developments of the invention are also provided. For instance, because the reflective coating is applied on the front, i.e., the outside of the carrier, and thus is not—unlike DE 80 34 459.8—protected by the material of the carrier, it is advantageous to provide a transparent protective coating on the reflective coating. This protective coating is preferably made of a silicate.

In another advantageous embodiment, the reflective coating may be chromium, aluminum, titanium or alloys of these elements.

If, in accord with a further advantageous embodiment, the carrier incorporates unitarily constructed, integrally molded, holding elements for its securement in or on the housing, then the mounting of the invented rearview mirror is substantially simplified and can be automated.

In accord with yet another advantageous embodiment, a positional adjustable mechanism can be provided to pivot the housing and the mirror element together, or the mirror alone within the housing.

Further, the carrier can be composed of an opaque plastic; i.e., contrary to DE 80 34 459.8, the carrier may consist of a plastic without high optical qualities. Thus, the carrier can be economical to manufacture and procure.

### BRIEF DESCRIPTION OF THE DRAWINGS

Further details, aspects and advantages of the present invention become evident in the following description of embodiments with the aid of the drawings. There is shown in:

FIG. 1 a profile sectional view through a carrier;

FIG. 2 the carrier as in FIG. 1 mounted in a mirror housing; and

FIG. 3 a partial sectional view of an adaption of the rearview mirror of FIG. 2.

### DETAILED DESCRIPTION OF THE INVENTION

Detailed reference will now be made to the drawings in which examples embodying the present invention are shown. The drawings and detailed description provide a full and detailed written description of the invention, and of the manner and process of making and using it, so as to enable one skilled in the pertinent art to make and use it, as well as the best mode of carrying out the invention. However, the examples set forth in the drawings and detailed description are provided by way of explanation of the invention and are not meant as limitations of the invention. The present invention thus includes any modifications and variations of the following examples as come within the scope of the appended claims and their equivalents.

In the following description, the same parts, or parts which correspond to one another are provided with the same reference numbers in alternate embodiments. Again, the following description is purely illustrative and is not to be considered as limiting.

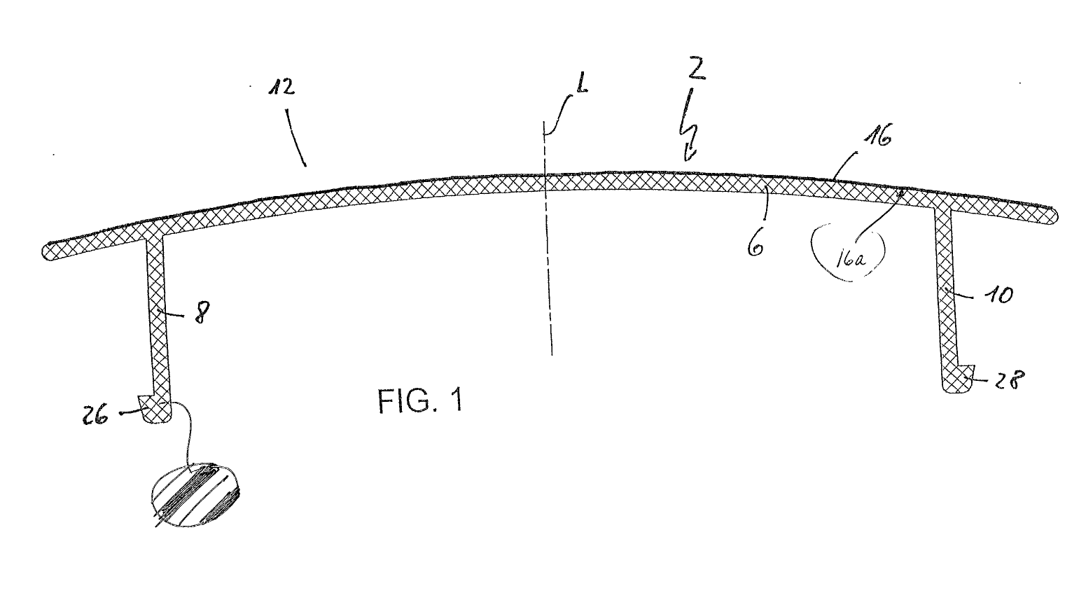

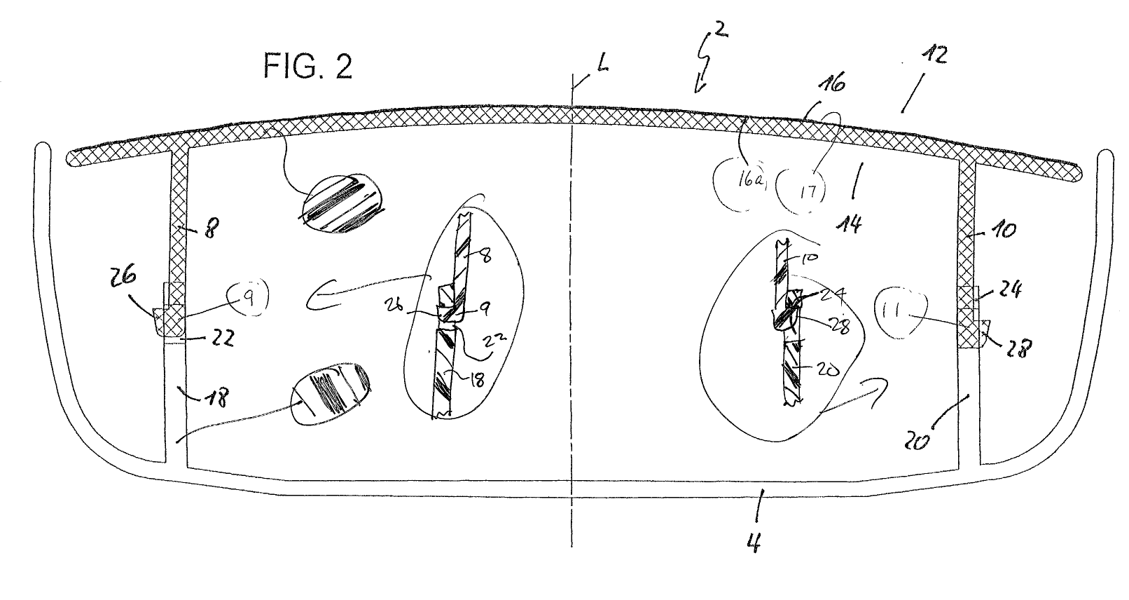

FIG. 1 shows in a sectional profile, one carrier or one carrier part 6, which is a component of the invented rearview mirror. FIG. 2 shows the mounting conditions when the carrier 2 is placed within a mirror housing 4.

The carrier part 6 exhibits an outwardly bulging construction and is formed in mirror image symmetry along an axis L. However, this mirror image, symmetrical design is not necessarily a requirement.

The components of the carrier part 6 are predominately the characteristic carrier plate 2, and the first and second securement elements 8 and 10, respectively. The first and second securement elements 8 and 10 do not necessarily have to be unitarily constructed with the carrier plate 2. However, it is especially advantageous if the entire carrier part 6 is a one piece, molded plastic part. In this part, the material can be any structurally suitable plastic. That is, the material for the carrier part 6 is not required to show any special optical qualities but need only fulfill structural requirements for durability, tensile strength, weight and workability.

In accord with FIG. 2, the carrier plate 2 possesses an exterior 12 and an interior 14. The exterior 12 is positioned away from the mirror housing 4 and the interior 14 is within the housing 4.

On the exterior 12, a reflective coating 16 is applied onto the carrier plate 2. The reflective coating 16 can, for instance, comprise chromium, aluminum, titanium or alloys of these elements. The reflective coating 16 is applied to the exterior 12 of the carrier plate 2, for instance, by a chemical precipitation procedure, by a vapor deposition method, by sputtering, or the like. In a preferential operation, on the free outside 16a of the reflective coating 16, a protective coating (not shown in detail) is applied, for example, a coating of a silicate. This protective coating 17 guards the reflective coating 16 from harmful mechanical, chemical or atmospheric influences.

One can infer from FIG. 2 how the first and second securement elements 8 and 10 interact with the corresponding first and second countersecurements 18 and 20. The first and second countersecurement elements 18 and 20 are, in the illustrated embodiment, one piece, outstanding projections integral with the mirror housing 4. The first and second countersecurements 18 and 20 possess receiving openings 22 and 24, respectively, into which free ends 9, 11 of the first and second securement elements 8 and 10, respectively, penetrate. Further, latch protuberances 26 and 28, depending from first and second securement elements 8 and 10, respectively, resiliently engage receiving openings 22 and 24, respectively. By this means, the carrier plate 2 is inseparably bound to the mirror housing 4.

On the mirror housing 4 is placed in a known manner at least one holding arm (not shown) with which the mirror housing 4 is secured to the vehicle body. Between the mirror housing 4 and the holding arm, again in a conventional manner, may be interposed a position adjustment mechanism (not shown). Alternately, instead of the connection between the opening 22, 24 and the latch protuberance 26, 28, the position adjustment mechanism may be placed between the carrier plate 2 and the mirror housing 4. In this way, and in a known manner, the mirror housing 4 can be adjustably held in relation to the carrier plate 2.

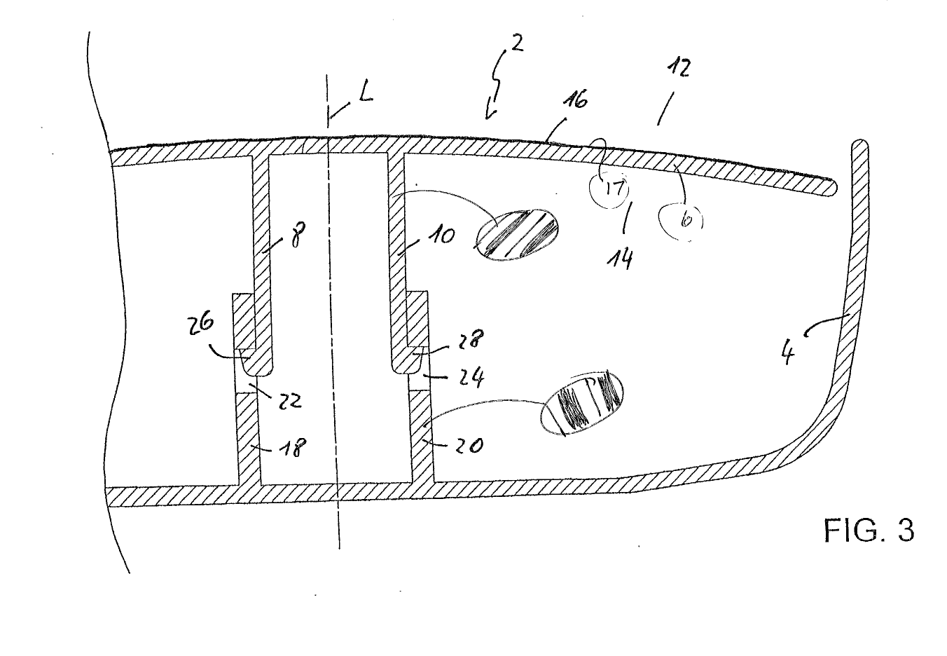

FIG. 3 shows another embodiment of the present invention in which the first and second securement elements 8 and 10 are in the direct vicinity of the central axis L. Here, the first and second securement elements 8 and 10 again possess the latch protuberances 26 and 28 that engage in the corresponding openings 22 and 24 of the first and second countersecurements 18 and 20. First and second countersecurements 18 and 20, in the illustrated example, are depicted as one integral part with the mirror housing 4. Also in the embodiment in accord with FIG. 3, the connection between the latch protuberances 26 and 28 and the openings 22 and 24 can be substituted with a mid-point, central position adjustment mechanism (not shown) to adjustably hold the mirror housing 4 in relation to the carrier plate 2 as noted above.

Also in the embodiment according to FIG. 3, the reflective coating 16 is applied onto the exterior 12 of the carrying piece 6 as previously described.

In the embodiments shown in the drawings, including FIGS. 1, 2, and 3, the reflective coating 16 is applied on the exterior 12 of the carrier 6. The carrier 6, then, no longer serves for the support and bearing of a separate mirror element, for instance, a coated glass plate or the like.

Furthermore, the carrier plate 2 is not treated on its interior 14 with the reflective coating 16, which means that the material of the carrier plate 2 is not required to possess any special optical qualities. Expensive finishing steps, e.g., polishing, related to the carrier plate 2 on its interior 14 before the application of the reflective coating 16 may be dispensed with since the reflective coating 16 is applied directly onto the outside 16a and subsequently treated with a protective coating 17.

The objectives of the present invention have advantages over the rearview mirror as defined by DE 80 34 459.8 in that the present invention dispenses with the combination of a carrier 6 plus a characteristic mirror element as two separate components. This is advantageous in consideration of:

manufacturing cost;

weight; and

vibration tendencies, etc.

Further, the present invention avoids the disadvantages of DE 80 34 459.8 arising from carrier 6 having the reflective layer 16 applied to its interior 14.

It will be apparent to those skilled in the art that various modifications and variations can be made in the present invention without departing from the scope and spirit of the invention. The present invention is intended to include such modifications and variations as come within the scope of the appended claims and their equivalents.

Claimed is:

1. A rearview mirror, especially for motor vehicles, with
a support arm
a housing (4) affixed to said support arm
a mirror element placed on or within said housing (4),
which said mirror element has a plastic carrier (2, 6) possessing a outer, or front side (12) proximal to the outside of the housing 4 and possessing an inner, or back side (14) proximal to the interior of the housing (4), and upon which carrier a reflective coating (16) is applied, therein characterized, in that the reflective coating (16) is applied on the said front side (12).

2. A rearview mirror in accord with claim 1, therein characterized, in that the reflective coating (16) is covered by a transparent protective layer, especially a layer of silicate.

3. A rearview mirror in accord with claim 1 or claim 2, therein characterized, in that the reflective coating (16) is comprised of chromium, aluminum, titanium or alloys of said elements.

4. A rearview mirror in accord with one of the foregoing claims, therein characterized, in that, the carrier (6) possesses one-piece, integrally molded securement elements (8, 10) for attachment on or within the housing (4).

5. A rearview mirror in accord with one of the foregoing claims, characterized by a positioning adjustment mechanism for the pivoting of the housing (4) together with the mirror element (6, 16) or alternately for the pivoting of the said mirror element (6, 16) within the housing (4).

6. A rearview mirror in accord with one of the foregoing claims, therein characterized, in that the carrier (6) is composed of an opaque plastic.
